(19) United States
(12) Patent Application Publication
(10) Pub. No.: US 2024/0384107 A1
(43) Pub. Date: Nov. 21, 2024

(54) AUTOMOTIVE PAINTING PRODUCTS WITH IMPROVED HEAT RESISTANCE AND LIGHT RESISTANCE

(71) Applicants: Hyundai Motor Company, Seoul (KR); Kia Corporation, Seoul (KR); Cho Kwang Paint Co., Ltd., Busan (KR)

(72) Inventors: Chan Ul Jeong, Ansan (KR); Ho Tak Jeon, Hwaseong (KR); Seung Goo Lee, Cheongju (KR); Jung In Kim, Gwangju (KR)

(21) Appl. No.: 18/385,241

(22) Filed: Oct. 30, 2023

(30) Foreign Application Priority Data
May 17, 2023 (KR) 10-2023-0063448

(51) Int. Cl. C09D 4/06; B05D 7/00; C08F 222/10; C09D 7/20; C09D 7/48; C09D 133/08; C09D 175/04

(52) U.S. Cl. CPC C09D 4/06; B05D 7/536; C08F 222/102; C08F 222/103; C08F 222/1065; C09D 7/20; C09D 7/48; C09D 133/08; C09D 175/04; B05D 2201/02; B05D 2420/01; B05D 2420/02; B05D 2502/00; B05D 2503/00

(57) ABSTRACT

Disclosed is an automotive painting product including a base color layer that is located on a substrate layer and includes a thermosetting paint composition and a clear layer that is located on the base color layer and includes a UV-curable paint composition. The thermosetting paint composition includes (i) a main portion including a first acrylic resin, a second acrylic resin having lower Tg than the first acrylic resin, a first surface conditioner, a curing accelerator, and a first organic solvent, and (ii) a curing portion including a curing agent containing an isocyanate group and a second organic solvent. The UV-curable paint composition includes at least two acrylate oligomers having different numbers of functional groups, an acrylate monomer, a photoinitiator, a second surface conditioner, a UV stabilizer, and a third organic solvent.

### CROSS-REFERENCE TO RELATED APPLICATION

This application claims, under 35 U.S.C. § 119 (a), the benefit of priority from Korean Patent Application No. 10-2023-0063448, filed on May 17, 2023, the entire contents of which are incorporated herein by reference.

### TECHNICAL FIELD

The present disclosure relates to an automotive painting product. The automotive painting product includes a substrate layer coated with an undercoat layer including a thermosetting paint composition and a top coat layer including a UV-curable paint composition.

### BACKGROUND

Recently, in the automobile industry, the demand for high-gloss painting has been increasing. In particular, black high-gloss paint is required for luxury vehicles. However, high-gloss painting is vulnerable to scratches, and furthermore, black-based colors have a disadvantage in that scratches are easily identified with the naked eye.

Moreover, most existing high-gloss automotive parts use heat-drying urethane paints.

In the case of heat-drying urethane paints, limitations are imposed on increasing surface hardness after completion of drying due to the characteristics of the paint polymer resin. With the goal of overcoming such problems, a double coating method using UV-photocurable paint is being applied.

However, A-ZONE parts that are exposed to high temperatures or strong UV light among automotive interior parts are problematic in that cracking occurs due to high hardness of the paint under high temperature/strong UV exposure conditions.

Against the above background, there is a need for a method of painting an automotive interior part having superior light resistance as well as high surface hardness even at high temperatures.

### SUMMARY

In preferred aspects, provided is an automotive painting product having improved heat resistance and light resistance.

In an aspect, provided is an automotive painting product, including a base color layer located on a substrate layer and including a thermosetting paint composition and a clear layer located on the base color layer and including a UV-curable paint composition. The thermosetting paint composition includes (i) a main portion including a first acrylic resin, a second acrylic resin having a lower glass transition temperature (Tg) than the first acrylic resin, a first surface conditioner, a curing accelerator, and a first organic solvent, and (ii) a curing portion including a curing agent containing an isocyanate group and a second organic solvent. The UV-curable paint composition includes at least two acrylate oligomers having different numbers of functional groups, an acrylate monomer, a photoinitiator, a second surface conditioner, a UV stabilizer, and a third organic solvent.

The “base color layer” may be formed of a material including a pigment or coloring substance which can reflect a visible light of a specific wave length of a specific color (e.g., blue, red, green, yellow, and the like).

The “clear layer” may be formed of a material having substantial transmittance of a fraction of light, such as visible light. For instance, the substantial amount of visible light such as of about 50%, about 60%, about 70%, about 80%, about 90%, about 95%, about 99%, or greater thereof may transmit or pass through the clear layer.

The main portion may include, based on the total weight of the main portion, an amount of about 10 to 30 wt % of the first acrylic resin, an amount of about 10 to 30 wt % of the second acrylic resin, an amount of about 0.01 to 5 wt % of the first surface conditioner, an amount of about 0.01 to 1 wt % of the curing accelerator, and an amount of about 40 to 60 wt % of the first organic solvent, and the curing portion may include, based on the total weight of curing portion, an amount of about 40 to 60 wt % of the curing agent and a balance of the second organic solvent.

Each of the first acrylic resin and the second acrylic resin may include an amount of about 10 wt % or less of a total of hydroxyl groups, and each the first acrylic resin and the second acrylic resin may have a weight average molecular weight (Mw) of about 10,000 to 150,000 g/mol.

A difference in glass transition temperature (Tg) between the first acrylic resin and the second acrylic resin may be about 4 to 15° C.

The first acrylic resin may have a glass transition temperature (Tg) of about 80 to 90° C., and the second acrylic resin may have a glass transition temperature (Tg) of about 70 to 80° C.

The curing accelerator may include dibutyltin dilaurate.

The UV-curable paint composition may include, based on the total weight of the UV-curable paint composition, an amount of about 10 to 30 wt % of the acrylate monomer, an amount of about 20 to 40 wt % of the acrylate oligomers, an amount of about 1 to 5 wt % of the photoinitiator, an amount of about 0.01 to 5 wt % of the second surface conditioner, an amount of about 0.01 to 5 wt % of the UV stabilizer, and an amount of about 30 to 70 wt % of the third organic solvent.

The acrylate monomer may have 1 to 3 functional groups.

The acrylate oligomers may have 2 to 6 functional groups.

The acrylate oligomers may include a first acrylate oligomer having 5 to 6 functional groups and a second acrylate oligomer having 2 to 4 functional groups, and a weight ratio of the first acrylate oligomer to the second acrylate oligomer may be about 5:1 to 1:5.

The acrylate oligomers may be a urethane acrylate oligomer having at least two acryl groups.

The acrylate oligomers may have a weight average molecular weight (Mw) of about 500 to 3,500 g/mol.

The first organic solvent, the second organic solvent, and the third organic solvent may include at least one selected from the group consisting of an acetate-based solvent, a ketone-based solvent, an alcohol-based solvent, and combinations thereof.

The substrate layer may include a plastic injection-molded product.

Also provided is a vehicle including the automotive painting product as described herein.

Other aspects of the invention are disclosed infra.

### BRIEF DESCRIPTION OF THE DRAWING

FIG. 1 shows a cross-sectional view of an exemplary automotive painting product according to an exemplary embodiments of the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

All numbers, values and/or expressions representing amounts of components, reaction conditions, polymer compositions and blends used in the description are approximations in which various uncertainties in measurement generated when these values are acquired from essentially different things are reflected and thus it will be understood that they are modified by the term “about”, unless stated otherwise. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In certain preferred aspects, a vehicle may be electric-powered, including a hybrid vehicles, plug-in hybrids, or vehicles where electric power is the primary or sole power source.

The present disclosure pertains to an automotive painting product.

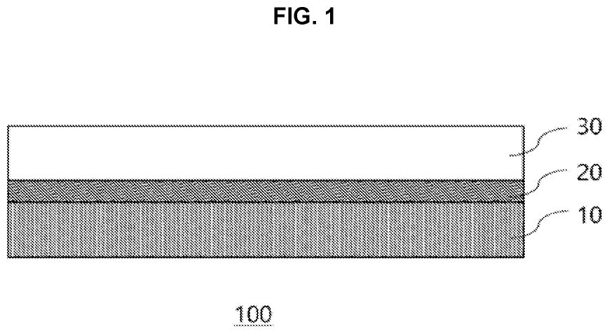

Hereinafter, a detailed description will be given of the present disclosure with reference to the accompanying drawing. FIG. 1 schematically shows a cross-sectional view of an automotive painting product according to the present disclosure.

As shown in FIG. 1, an automotive painting product 100 according to an exemplary embodiment of the present disclosure includes a base color layer 20 located on a substrate layer 10 and including a thermosetting paint composition, and a clear layer 30 located on the base color layer 20 and including a UV-curable paint composition.

The thermosetting paint composition includes (i) a main portion including a first acrylic resin, a second acrylic resin having a lower glass transition temperature (Tg) than the first acrylic resin, a first surface conditioner, a curing accelerator, and a first organic solvent, and (ii) a curing portion including a curing agent containing an isocyanate group and a second organic solvent. The UV-curable paint composition includes at least two acrylate oligomers having different numbers of functional groups, an acrylate monomer, a photoinitiator, a second surface conditioner, and a UV stabilizer, and a third organic solvent.

### (A) Substrate Layer

The substrate layer 10 is a layer configured to apply the base color layer 20 thereon and is located at the bottom.

The substrate layer 10 is not particularly limited, so long as it is a paintable material. For example, a plastic injection-molded product for automobiles may be used.

### (B) Base Color Layer

The base color layer 20 is a layer that is coated with the clear layer 30, and is interposed between the substrate layer 10 and the clear layer 30.

The base color layer 20 includes a thermosetting paint composition.

Preferably, the base color layer 20 is a layer capable of showing a color required for design, and the thermosetting paint composition may further include a color pigment such as black carbon.

The thermosetting paint composition may include a two-component mixed solution including a main portion and a curing portion. The main portion and the curing portion may be mixed in a weight ratio of about 5-10:1.

The main portion may include a first acrylic resin, a second acrylic resin, a first surface conditioner, a curing accelerator, and a first organic solvent.

The main portion may suitably include, based on the total weight of the total weight of the main portion, an amount of about 10 to 30 wt % of the first acrylic resin, an amount of about 10 to 30 wt % of the second acrylic resin, an amount of about 0.01 to 5 wt % of the first surface conditioner, an amount of about 0.01 to 1 wt % of the curing accelerator, and an amount of about 40 to 60 wt % of the first organic solvent.

The first acrylic resin and the second acrylic resin may be an acrylic polyol resin containing an amount of about 10 wt % or less of a total of hydroxyl groups. Preferably, the first acrylic resin and the second acrylic resin may include 1 to 10 wt % of the hydroxyl group.

The first acrylic resin and the second acrylic resin may have a weight average molecular weight (Mw) of about 10,000 to 150,000 g/mol.

In the thermosetting paint composition, the second acrylic resin having a lower glass transition temperature (Tg) than the first acrylic resin is used.

Preferably, a difference in glass transition temperature (Tg) between the first acrylic resin and the second acrylic resin may be about 4 to 15° C.

The first acrylic resin may have a glass transition temperature (Tg) of about 80 to 90° C., and the second acrylic resin may have a glass transition temperature (Tg) of about 70 to 80° C.

The first surface conditioner may suitably include a non-silicone-based surface conditioner.

The curing accelerator may suitably include dibutyltin dilaurate.

The first organic solvent may suitably include one or more selected from the group consisting of acetate-based solvents, ketone-based solvents, and alcohol-based solvents. The curing portion may include a curing agent and a second organic solvent.

The curing portion may suitably include an amount of about 40 to 60 wt % of the curing agent and a balance of the second organic solvent based on the total weight of the curing portion.

The curing agent may be a curing agent containing an isocyanate group.

The second organic solvent may suitably include acetate-based solvents, ketone-based solvents, or combinations thereof.

### (C) Clear Layer

The clear layer 30 is the outermost layer of the automotive painting product 100 and is located on the base color layer 20.

The clear layer 30 may be a transparent layer configured to protect the base color layer 20.

The clear layer 30 includes a UV-curable paint composition. Unlike the thermosetting paint composition, the UV-curable paint composition may be of a one-component type.

The UV-curable paint composition may suitably include an acrylate monomer, an acrylate oligomer, a photoinitiator, a second surface conditioner, a UV stabilizer, and a third organic solvent.

The UV-curable paint composition may suitably include, based on the total weight of the UV-curable paint, an amount of about 10 to 30 wt % of the acrylate monomer, an amount of about 20 to 40 wt % of the acrylate oligomer, an amount of about 1 to 5 wt % of the photoinitiator, an amount of about 0.01 to 5 wt % of the second surface conditioner, an amount of about 0.01 to 5 wt % of the UV stabilizer, and an amount of about 30 to 70 wt % of the third organic solvent.

The acrylate monomer may have 1 to 3 functional groups.

The acrylate monomer may include at least two acrylate monomers.

The acrylate monomer may include a first acrylate monomer having one functional group, a second acrylate monomer having two functional groups, and a third acrylate monomer having three functional groups.

The third acrylate monomer is added to adjust workability and coating leveling during painting.

The mixed amount of the first acrylate monomer and the second acrylate monomer may be about 1 to 3 wt % based on the total weight of the UV-curable paint composition.

The amount of the third acrylate monomer may be about 5 to 15 wt % based on the total weight of the UV-curable paint composition.

When the amount of the acrylate monomer is less than about 5 wt %, orange peel defects may occur on the painted surface, which is undesirable. On the other hand, when the amount of the acrylate monomer is greater than about 15 wt %, the painted surface may flow due to excessive use thereof.

In the UV-curable paint composition, at least two acrylate oligomers having different numbers of functional groups are used.

The acrylate oligomers may have a weight average molecular weight (Mw) of about 500 to 3,500 g/mol.

The acrylate oligomers may be a urethane acrylate oligomer having at least two acryl groups.

The acrylate oligomers may be bifunctional or higher polyfunctional urethane acrylate oligomers. For example, the acrylate oligomers may have 2 to 6 functional groups.

The acrylate oligomers may include a first acrylate oligomer having 5 to 6 functional groups and a second acrylate oligomer having 2 to 4 functional groups. Here, the second acrylate may be a mixture of acrylate having two functional groups and acrylate having three functional groups.

The acrylate oligomers may include the first acrylate oligomer and the second acrylate oligomer mixed in a weight ratio of about 5:1 to 1:5.

The photoinitiator may suitably include a hydroxycyclohexyl phenyl ketone-based photoinitiator.

The second surface conditioner may suitably include a silicone-based surface conditioner.

The UV stabilizer may suitably include a hydroxyphenyltriazine derivative.

The third organic solvent may include acetate-based solvents, ketone-based solvents, alcohol-based solvents, or combinations thereof.

### EXAMPLE

A better understanding of the present disclosure may be obtained through the following examples. These examples are merely set forth to illustrate the present disclosure, and are not to be construed as limiting the scope of the present disclosure.

### Test Example 1

In order to evaluate the effect thereof on properties by adjusting the glass transition temperature (Tg) of the first acrylic resin and the second acrylic resin in the main portion of a thermosetting paint composition used for a base color layer, painting products according to Example 1 and Comparative Examples 1 to 4 were manufactured.

The painting products according to Example 1 and Comparative Examples 1 to 4 were manufactured in the following manner.

The painting products according to Example 1 and Comparative Examples 1 to 4 were manufactured by coating a plastic injection-molded product with a base color layer including a thermosetting paint composition and then coating the base color layer with a clear layer including a UV-curable paint composition.

The thermosetting paint composition may be composed of a 2-component mixed solution including a main portion and a curing portion.

The amounts of the components of the main portion of the thermosetting paint composition used in Example 1 and Comparative Examples 1 to 4 are shown in Table 1 below. The curing portion was composed of 40 to 60 wt % of a curing agent containing an isocyanate group and a balance of an organic solvent. Specifically, the main portion and the curing portion was mixed in a weight ratio of 5-10:1.

The UV-curable paint composition used in Example 1 and Comparative Examples 1 to 4 may be composed of a 1-component mixed solution. The amounts of the components of the UV-curable paint composition used in Example and Comparative Examples are shown in Table 2 below.

TABLE 1

| Component | | Comparative | Comparative | Comparative | Comparative |
|---|---|---|---|---|---|
| (wt %) | Example 1 | Example 1 | Example 2 | Example 3 | Example 4 |
| (A) First acrylic | 25 | 34.8 | 25 | 5.2 | 25 |
| resin | (Tg = 84° C.) | (Tg = 74° C.) | (Tg = 100° C.) | (Tg = 100° C.) | (Tg = 84° C.) |
| (B) Second | 15 | 5.2 | 15 | 34.8 | 15 |
| acrylic resin | (Tg = 78° C.) | (Tg = 71° C.) | (Tg = 84° C.) | (Tg = 74° C.) | (Tg = 78° C.) |
| (C) Surface | 3 | 3 | 3 | 3 | 3 |
| conditioner | | | | | |
| (D) Curing | 0.05 | 0.05 | 0.05 | 0.05 | 0 |
| accelerator | | | | | |
| (E) Additive | 0.2 | 0.2 | 0.2 | 0.2 | 0.2 |
| (F) UV stabilizer | 1 | 1 | 1 | 1 | 1 |
| (G) Solvent | 55.75 | 55.75 | 55.75 | 55.75 | 55.80 |
| Total | 100 | 100 | 100 | 100 | 100 |

[Component]
(A) First acrylic resin; Acrylic polyol resin - MPT's HF-5000HV (Tg = 84° C.), HF-6000HV (Tg = 71° C.), Dow's Paraloid A-11 (Mw: 125,500, Tg = 100° C.), etc.
(B) Second acrylic resin: Acrylic resin - Aekyung Chemical's AA-5501 (Tg = 78° C.), MPT's HF-5000HV (Tg = 84° C.), etc.
(C) Surface conditioner: Non-silicone-based surface conditioner, adhesion enhancer
(D) Curing accelerator: Dibutyltin dilaurate
(F) UV stabilizer: UVA, HALS, etc.
(G) Solvent: Acetate-based solvent, ketone-based solvent, alcohol-based solvent, etc.

TABLE 2

| | UV-curable paint |
|---|---|
| Component (wt %) | composition |
| (A1) Urethane acrylate oligomer (Functionality = 6) | 4.9 |
| (A2) Urethane acrylate oligomer (Functionality = 3) | 3.19 |
| (A3) Urethane acrylate oligomer (Functionality = 2) | 21.41 |
| (B1) Acrylate monomer (Functionality = 1) | 3 |
| (B2) Acrylate monomer (Functionality = 2) | 1 |
| (B3) Acrylate monomer (Functionality = 3) | 10 |
| (C) Photoinitiator | 3.5 |
| (D) UV stabilizer | 2 |
| (E) Additive | 1 |
| (F) Solvent | 50 |
| Total | 100 |
| Functionality ratio (X:Y) | 5:1 |
| wherein X = A1, Y = A2 + A3 | |

[Component]
(A1) Hexafunctional urethane acrylate oligomer: Ebecryl-1290 (Functionality = 6, Molecular weight = 1000), UP-118 (Functionality = 6, Molecular weight = 1000), Ebecryl-9390 (Functionality = 6, Molecular weight = 1000), MIRAMER PU-610 (Functionality = 6, Molecular weight = 1800), etc.
(A2) Trifunctional urethane acrylate oligomer: Ebecryl-9260 (Functionality = 3), Miwon Specialty Chemical's MIRAMER PU-340 (Functionality = 3, Molecular weight = 2400), etc.
(A3) Bifunctional urethane acrylate oligomer: ENTIS' Ebecryl-284 (Functionality = 2, Molecular weight = 1000), Ebecry1-9270 (Functionality = 2, Molecular weight = 1000), etc.
(C) Photoinitiator: Hydroxycyclohexyl phenyl ketone-based photoinitiator
(D) UV stabilizer: Hydroxyphenyltriazine derivative, UVA, HALS, etc.
(E) Additive: Silicone-based surface conditioner
(F) Solvent: Acetate-based solvent, ketone-based solvent, alcohol-based solvent, etc.

Differences in glass transition temperature (Tg) between the first acrylic resin and the second acrylic resin are shown in Table 3 below.

TABLE 3

| | Example | Comparative | Comparative | Comparative | Comparative |
|---|---|---|---|---|---|
| Classification | 1 | Example 1 | Example 2 | Example 3 | Example 4 |
| Difference in Tg between | 6° C. | 3° C. | 16° C. | 26° C. | 6° C. |
| first acrylic resin and | | | | | |
| second acrylic resin | | | | | |

In order to confirm performance of the painting products according to Example 1 and Comparative Examples 1 to 4, performance of test samples manufactured from the painting products according to Example 1 and Comparative Examples 1 to 4 were measured through evaluation of the following items. The results thereof are shown in Table 13 below.

### Evaluation Methods

(1) Appearance: After painting and drying a plastic material, cracking, pinholes, bubbles, foreign matter, orange peel defects, etc. on the painted surface were evaluated with the naked eye.

(2) Scratch resistance: Measurement was performed in accordance with JIS K 6718, and the surface state of the manufactured test sample was evaluated after scratching the surface thereof under conditions of the table.

Here, scratching was performed once using a scratcher with 3 mm, a shear of 0.5R, and a shear angle of 60° under conditions of a load of 4.9 N (0.5 kgf), a stroke of 100+5 mm, and a friction speed of 100 mm/sec.

(Evaluation criteria: 5=no surface damage, 4=slight surface damage, 3=slight or moderate surface damage, 2=surface damage, 1=severe surface damage)

(3) Adhesion: A tape peeling test was performed in accordance with ISO 2409 and JIS K 5600-5-6. Specifically, the surface of a test sample was cleaned with soft brush, and a piece of prescribed tape (JIS Z 1522) was firmly attached thereto and then detached therefrom strongly at an angle of 90°. The judgment is based on Table 4 below. Here, the middle of M-1.0 and M-2.0 is M-1.5.

TABLE 4

| Classification | Appearance |
|---|---|
| M-1.0 | (1) There should be no peeling of coating film at intersections of cutting |
| | (2) There should be no peeling along straight lines |
| M-2.0 | (1) Slight peeling of coating film appears at intersections of cutting |
| | (2) There should be no peeling along straight lines |
| M-3.0 | (1) Peeling of coating film at intersections of cutting is at level of 5-15% |
| | (2) Peeling along straight lines is noticed |
| | (3) Coating film on one side of checkerboard scales should not peel off 50% |
| | or more |
| M-4.0 | (1) Significantly noticeable peeling along straight lines |
| | (2) About 5 peeled checkerboard scales |
| M-5.0 | (1) Lots of peeling along straight lines |
| | (2) About 20 peeled checkerboard scales |
| M-6.0 | (1) All checkerboard scales peeled off |

(4) Impact resistance: Impact resistance evaluation was performed using a DUPONT impact tester to determine whether or not the coating film was peeled off.

(5) Moisture resistance: A specimen was allowed to stand under conditions shown in Table 5 below, taken out, and dewatered from the surface thereof by air blow, and allowed to stand at room temperature for 1 hour, and the surface state of the coating film was observed, and the adhesion test according to (3) above was immediately performed.

TABLE 5

| Classification | Test temperature (° C.) | Relative humidity (% RH) | Test time (h) |
|---|---|---|---|
| Interior | 50 ± 2 | 95 ± 2 | 168 |
| Exterior | | | 240 |

(6) Chemical resistance: Using chemicals specified in Table 6 below, the surface of the coating film was rubbed by 10 reciprocations with a force of about 4.0 N (0.5 kgf) and the appearance thereof was observed with the naked eye. Thereafter, the coating film was allowed to stand at room temperature for 1 hour, allowed to stand in a constant-temperature chamber at 80±2° C. for 3 hours, and then taken out, and the surface state of the coating film was observed.

TABLE 6

| Chemical name | Specification |
|---|---|
| Gasoline | Unleaded gasoline |
| Polishing wax | HMC/KMC genuine or equivalent |
| Glass cleaner | Weak alkaline GLASS CLEANER |
| Ethyl alcohol | Industrial ethyl alcohol |
| Acetone | Industrial acetone |

(7) Sunscreen resistance: Two white cotton cloths of the same size were stacked on an acrylic plate (50 mm×50 mm) and 0.25 g of sunscreen specified in the following table was applied onto the entire surface thereof. The sunscreen application area was placed on a specimen and pressed with the acrylic plate. The specimen was allowed to stand in a constant-temperature chamber at 80±2° C. for 1 hour and then taken out, and the white cotton cloths and the acrylic plate were removed therefrom. The specimen was allowed to stand at room temperature for about 10 to 15 minutes, washed with a neutral detergent, and dried.

Subsequently, the surface state of the coating film was observed, and the scratch test according to (2) above and the adhesion test according to (3) above were immediately performed under conditions shown in Table 7 below.

TABLE 7

| Sunscreen | White cotton cloth | Adhesion test | Scratch test |
|---|---|---|---|
| NIVEA | TOYOSYNTHETIC | Testing three | Testing once |
| SPF47 | CH2070-3 equivalent | times | at 0.8 kgf |

(8) Heat resistance: A specimen was allowed to stand under conditions shown in Table 8 below, taken out, and allowed to stand at room temperature for 1 hour, after which the surface state of the coating film was observed, and the adhesion test according to (3) above was immediately performed.

TABLE 8

| Classification | Test temperature (° C.) | Test time (h) |
|---|---|---|
| TYPE A | 110 ± 2 | 300 |
| TYPE B | 90 ± 2 | |
| TYPE C, D | 80 ± 2 | |

(9) Heat cycle resistance: A specimen was subjected to a cycle test shown in Table 9 below, taken out, and allowed to stand at room temperature for 1 hour, after which the surface state of the coating film was observed, and the adhesion test according to (3) above was immediately performed. Also, the surface state of the coating film was observed every 1 cycle.

TABLE 9

| Classification | 1 CYCLE | Test cycle number |
|---|---|---|
| TYPE A, B | 80 ± 2° C. × 3 h → | 3 |
| TYPE C, D | RT 1 h → −40 ± 2° C. × | 5 |
| | 3 h → RT 1 h → 50 ± 2° C., | |
| | 95 ± 2% RH × 7 h → RT 1 h | |

(10) Light resistance (method by XENON ARC): A specimen was irradiated with light under conditions of Table 10 below using a tester specified in ISO 105 or JIS L 0843. After determining the extent of discoloration and fading, adhesion by a checkerboard scale test has to be performed (in which the irradiation intensity at 320 nm or less is less than 1.5% of the total amount of irradiation intensity at 300 to 400 nm).

TABLE 10

| | Setting | BLACK PNL | Humidity in | Irradiation |
|---|---|---|---|---|
| Type | conditions | temperature | chamber | intensity *) |
| Relevant | 126 MJ/m² | 89 ± 3° C. | 50 ± 5% RH | 65-100 W/m² |
| part | | | | (300-400 nm) |

(11) Wear resistance: The surface of a specimen or a test sample manufactured under conditions equivalent thereto was abraded under conditions in Table 11 below, and evaluated according to the standard (Evaluation criteria: 5=no surface wear, 4=slight surface wear, 3=slight or moderate surface wear, 2=surface wear, 1=severe surface wear).

TABLE 11

| Items | Conditions |
|---|---|
| Load (kgf) | 0.5 (including weight of rubber) |
| Stroke (mm) | 100 ± 5 |
| Friction speed (reciprocation/min) | 30 |
| Cloth material | Double-sided cloth #10 |
| | (JIS L 3102) |
| Rubber | 20*20, R45 |
| Number of frictions | 500 reciprocations |

(12) Life scratch resistance: A test was performed using a reciprocating wear tester under conditions of Table 12 below. Thereafter, the test sample was wiped with a microfiber non-woven fabric (1 denier or less) to prevent scratching. Then, the test sample was placed on a table, and appearance thereof on the effective surface (16×60 mm) was observed with the naked eye at a general reading distance of 50 cm under natural light or an artificial light source of 6,500K (evaluation was performed three times with different rubbers and results of pass or fail were judged, but irregular abnormal scratches were excluded from the judgment).

TABLE 12

| Items | | Conditions |
|---|---|---|
| Load (kgf) | | 0.5 (including weight of rubber) |
| Stroke (mm) | | 100 ± 5 |
| Friction speed (reciprocation/min) | | 30 |
| Cotton cloth | Material | Cotton #425 |
| | | (Test Fabrics Cotton Flannel |
| | | equivalent) |
| | Size | |

| | |
|---|---|
| Rubber | 20*20, R45 |

The life scratch resistance test was performed 300 times in a dry manner and performed 100 times in a wet manner of applying 0.1 ml of water onto the friction portion.

(13) Fragrance resistance: A test was performed with a fragrance evaluation solution using a pipette and the painted surface was visually evaluated.

TABLE 13

| | | | Comparative | Comparative | Comparative | Comparative |
|---|---|---|---|---|---|---|
| NO | Test items | Example 1 | Example 1 | Example 2 | Example 3 | Example 4 |
| 1 | Appearance | No | No | No | No | No |
| | | abnormality | abnormality | abnormality | abnormality | abnormality |
| 2 | Scratch | Grade 4 | Grade 4 | Grade 4 | Grade 4 | Grade 4 |
| | resistance | | | | | |
| 3 | Adhesion | M-1.0 | M-1.0 | M-1.0 | M-1.0 | M-5.0 |
| 4 | Impact | No film | No film | No film | No film | No film |
| | resistance | peeling | peeling | peeling | peeling | peeling |
| 5 | Moisture | M-1.0, Color | M-1.0, | M-4.5, | M-1.5, | M-5.0, |
| | resistance | difference | Color | Color | Color | Color |
| | | (ΔE*): 0.182 | difference | difference | difference | difference |
| | | GRAY | (ΔE*): | (ΔE*): | (ΔE*): | (ΔE*): |
| | | SCALE: | 0.189 | 0.080 | 0.121 | 0.157 |
| | | grade 4 | GRAY | GRAY | GRAY | GRAY |
| | | | SCALE: | SCALE: | SCALE: | SCALE: |
| | | | grade 4 | grade 4 | grade 4 | grade 4 |
| 6 | Chemical | GRAY | GRAY | GRAY | GRAY | GRAY |
| | resistance | SCALE: | SCALE: | SCALE: | SCALE: | SCALE: |
| | | grade 4 | grade 4 | grade 4 | grade 4 | grade 4 |
| 7 | Sunscreen | M-1.0, | M-1.0, | M-1.0, | M-1.0, | M-5.0, |
| | resistance | GRAY | GRAY | GRAY | GRAY | GRAY |
| | | SCALE: | SCALE: | SCALE: | SCALE: | SCALE: |
| | | grade 4 | grade 4 | grade 4 | grade 4 | grade 4 |
| 8 | Heat | M-1.0, Color | M-1.0, | M-1.0, | M-1.0, | M-1.0, |
| | resistance | difference | Color | Color | Color | Color |
| | | (ΔE*): 0.081 | difference | difference | difference | difference |
| | | GRAY | (ΔE*): | (ΔE*): | (ΔE*): | (ΔE*): |
| | | SCALE: | 0.181 | 0.131 | 0.172 | 0.185 |
| | | grade 4 | GRAY | GRAY | GRAY | GRAY |
| | | | SCALE: | SCALE: | SCALE: | SCALE: |
| | | | grade 4 | grade 4 | grade 4 | grade 4 |
| 9 | Heat cycle | M-1.5, Color | M-1.5, | M-1.0, | M-1.0, | M-1.0, |
| | resistance | difference | Color | Color | Color | Color |
| | | (ΔE*): | difference | difference | difference | difference |
| | | 0.080GRAY | (ΔE*): | (ΔE*): | (ΔE*): | (ΔE*): |
| | | SCALE: | 0.084 | 0.048 | 0.083 | 0.176 |
| | | grade 4 | GRAY | GRAY | GRAY | GRAY |
| | | | SCALE: | SCALE: | SCALE: | SCALE: |
| | | | grade 4 | grade 4 | grade 4 | grade 4 |
| 10 | Light | M-1.5, Color | M-1.5, | M-1.5, | M-1.5, | M-1.5, |
| | resistance | difference | Color | Color | Color | Color |
| | | (ΔE*): 0.344 | difference | difference | difference | difference |
| | | GRAY | (ΔE*): | (ΔE*): 0208 | (ΔE*): | (ΔE*): |
| | | SCALE: | 0.492 | GRAY | 0.270 | 0.195 |
| | | grade 4 | GRAY | SCALE: | GRAY | GRAY |
| | | | SCALE: | grade 4, | SCALE: | SCALE: |
| | | | grade 4, | cracking | grade 4, | grade 4, |
| | | | cracking | | cracking | cracking |
| 11 | Wear | No | No | No | No | No |
| | resistance | abnormality | abnormality | abnormality | abnormality | abnormality |
| 12 | Life scratch | No | No | No | No | No |
| | resistance | abnormality | abnormality | abnormality | abnormality | abnormality |
| 13 | Fragrance | No | No | No | No | No |
| | resistance | abnormality | abnormality | abnormality | abnormality | abnormality |
| | Judgment | Pass | Fail | Fail | Fail | Fail |

As shown in Table 13, the painting product according to Example 1 of the present disclosure was capable of increasing adhesion to the plastic material and satisfying requirements for heat resistance and light resistance upon evaluation of properties of interior parts (for A-ZONE).

In addition, since the glass transition temperature (Tg) of the acrylic resin in the thermosetting paint composition included in the undercoat layer (base color layer) affected stability of the coating film, the painting product according to Example 1 of the present disclosure was increased in coating stability by reducing the difference between acrylic resins through a number of variance tests.

Moreover, in the painting product according to Example 1 of the present disclosure, the thermosetting paint composition of a 2-component type included a curing portion using an isocyanate curing agent, thereby minimizing the fluidity of the coating film due to reaction of the curing portion with some hydroxyl groups of the main portion.

Thereby, the painting product according to Example 1 of the present disclosure was capable of maintaining thermal deformation stability of the plastic material, the undercoat layer (base color layer), and the top coat layer (clear layer), thus suppressing peeling and cracking of the coating film upon evaluation of properties.

### Test Example 2

In order to evaluate the effect thereof on properties by adjusting the amounts of acrylate oligomers having different numbers of functional groups in the components of a UV-curable paint composition used for a clear layer, painting products according to Examples and Comparative Examples were manufactured.

The painting products according to Examples 2 to 6 and Comparative Examples 5 to 6 were manufactured in the following manner.

The painting products according to Examples 2 to 6 and Comparative Examples 5 to 6 were manufactured by coating a plastic injection-molded product with a base color layer including a thermosetting paint composition and then coating the base color layer with a clear layer including a UV-curable paint composition.

The thermosetting paint composition used in Examples 2 to 6 and Comparative Examples 5 and 6 may be composed of a 2-component mixed solution including a main portion and a curing portion. The thermosetting paint composition was the same as that used in Example 1.

The UV-curable paint composition used in Examples 2 to 6 and Comparative Examples 5 and 6 may be composed of a 1-component mixed solution. The amounts of the components of the UV-curable paint composition used in Examples and Comparative Examples are shown in Table 14 below.

TABLE 14

| Component | Comparative | Example | Example | Example | Example | Example | Comparative |
|---|---|---|---|---|---|---|---|
| (wt %) | Example 5 | 2 | 3 | 4 | 5 | 6 | Example 6 |
| (A1) Urethane acrylate | 29.5 | 24.6 | 20.05 | 14.75 | 9.45 | 4.9 | 0 |
| oligomer | | | | | | | |
| (Functionality = 6) | | | | | | | |
| (A2) Urethane acrylate | 0 | 0.64 | 1.23 | 1.91 | 2.60 | 3.19 | 3.83 |
| oligomer | | | | | | | |
| (Functionality = 3) | | | | | | | |
| (A3) Urethane acrylate | 0 | 4.27 | 8.22 | 12.84 | 17.45 | 21.41 | 26.67 |
| oligomer | | | | | | | |
| (Functionality = 2) | | | | | | | |
| (B1) Acrylate monomer | 3 | 3 | 3 | 3 | 3 | 3 | 3 |
| (Functionality = 1) | | | | | | | |
| (B2) Acrylate monomer | 1 | 1 | 1 | 1 | 1 | 1 | 1 |
| (Functionality = 2) | | | | | | | |
| (B3) Acrylate monomer | 10 | 10 | 10 | 10 | 10 | 10 | 10 |
| (Functionality = 3) | | | | | | | |
| (C) Photoinitiator | 3.5 | 3.5 | 3.5 | 3.5 | 3.5 | 3.5 | 3.5 |
| (D) UV stabilizer | 2 | 2 | 2 | 2 | 2 | 2 | 2 |
| (E) Additive | 1 | 1 | 1 | 1 | 1 | 1 | 1 |
| (F) Solvent | 50 | 50 | 50 | 50 | 50 | 50 | 50 |
| Total | 100 | 100 | 100 | 100 | 100 | 100 | 100 |
| Functionality ratio | 6:0 | 5:1 | 4:2 | 3:3 | 2:4 | 1:5 | 0:6 |
| (X:Y) | | | | | | | |
| wherein X = A1, | | | | | | | |
| Y = A2 + A3 | | | | | | | |

[Component]
(A1) Hexafunctional urethane acrylate oligomer: Ebecryl-1290 (Functionality = 6, Molecular weight = 1000), UP-118 (Functionality = 6, Molecular weight = 1000), Ebecry1-9390 (Functionality = 6, Molecular weight = 1000), MIRAMER PU-610 (Functionality = 6, Molecular weight = 1800), etc.
(A2) Trifunctional urethane acrylate oligomer: Ebecryl-9260 (Functionality = 3), Miwon Specialty Chemical's MIRAMER PU-340 (Functionality = 3, Molecular weight = 2400), etc.
(A3) Bifunctional urethane acrylate oligomer: ENTIS's Ebecryl-284 (Functionality = 2, Molecular weight = 1000), Ebecryl-9270 (Functionality = 2, Molecular weight = 1000), etc.
(C) Photoinitiator: Hydroxycyclohexyl phenyl ketone-based photoinitiator
(D) UV stabilizer: Hydroxyphenyltriazine derivative, UVA, HALS, etc.
(E) Additive: Silicone-based surface conditioner
(F) Solvent: Acetate-based solvent, ketone-based solvent, alcohol-based solvent, etc.

In order to confirm performance of the painting products according to Examples 2 to 6 and Comparative Examples 5 to 6 , performance of test samples manufactured from the painting products according to Examples 2 to 6 and Comparative Examples 5 to 6 was measured through evaluation of the above items. The results thereof are shown in Tables 15 and 16 below.

TABLE 15

| | | Comparative | | | |
|---|---|---|---|---|---|
| NO | Test items | Example 5 | Example 2 | Example 3 | Example 4 |
| 1 | Appearance | Cracking (Fail) | No abnormality | No abnormality | No abnormality |
| 2 | Scratch | Grade 4 | Grade 4 | Grade 4 | Grade 4 |
| | resistance | | | | |
| 3 | Adhesion | M-1.5 | M-1.5 | M-1.5 | M-1.5 |
| 4 | Impact | No film peeling | No film peeling | No film peeling | No film peeling |
| | resistance | | | | |
| 5 | Moisture | M-1.5, Color | M-1.5, Color | M-1.5, Color | M-1.5, Color |
| | resistance | difference (ΔE*): | difference (ΔE*): | difference (ΔE*): | difference (ΔE*): |
| | | 0.177 | 0.132 | 0.043 | 0.095 |
| | | GRAY SCALE: | GRAY SCALE: | GRAY SCALE: | GRAY SCALE: |
| | | grade 4 | grade 4 | grade 4 | grade 4 |
| 6 | Chemical | GRAY SCALE: | GRAY SCALE: | GRAY SCALE: | GRAY SCALE: |
| | resistance | grade 4 | grade 4 | grade 4 | grade 4 |
| 7 | Sunscreen | M-1.5, GRAY | M-1.5, GRAY | M-1.5, GRAY | M-1.0, GRAY |
| | resistance | SCALE: grade 4 | SCALE: grade 4 | SCALE: grade 4 | SCALE: grade 4 |
| 8 | Heat resistance | M-1.5, Color | M-1.5, Color | M-1.5, Color | M-1.0, Color |
| | | difference (ΔE*): | difference (ΔE*): | difference (ΔE*): | difference (ΔE*): |
| | | 0.163 | 0.414 | 0.152 | 0.092 |
| | | GRAY SCALE: | GRAY SCALE: | GRAY SCALE: | GRAY SCALE: |
| | | grade 4 | grade 4 | grade 4 | grade 4 |
| 9 | Heat cycle | M-1.5, Color | M-1.5, Color | M-1.5, Color | M-1.5, Color |
| | resistance | difference (ΔE*): | difference (ΔE*): | difference (ΔE*): | difference (ΔE*): |
| | | 0.141 | 0.133 | 0.043 | 0.095 |
| | | GRAY SCALE: | GRAY SCALE: | GRAY SCALE: | GRAY SCALE: |
| | | grade 4 | grade 4 | grade 4 | grade 4 |
| 10 | Light resistance | M-2.0, Color | M-2.0, Color | M-1.5, Color | M-1.5, Color |
| | | difference (ΔE*): | difference (ΔE*): | difference (ΔE*): | difference (ΔE*): |
| | | 0.184 | 0.110 | 0.101 | 0.106 |
| | | GRAY SCALE: | GRAY SCALE: | GRAY SCALE: | GRAY SCALE: |
| | | grade 4 | grade 4 | grade 4 | grade 4 |
| 11 | Wear resistance | No abnormality | No abnormality | No abnormality | No abnormality |
| 12 | Life scratch | No abnormality | No abnormality | No abnormality | No abnormality |
| | resistance | | | | |
| 13 | Fragrance | No abnormality | No abnormality | No abnormality | No abnormality |
| | resistance | | | | |
| 14 | Functionality | 6:0 | 5:1 | 4:2 | 3:3 |
| | ratio (X:Y) | | | | |
| | Judgment | Fail | Pass | Pass | Pass |

TABLE 16

| | | | | Comparative |
|---|---|---|---|---|
| NO | Test items | Example 5 | Example 6 | Example 6 |
| 1 | Appearance | No abnormality | No abnormality | No abnormality |
| 2 | Scratch | Grade 4 | Grade 4 | Grade 2.5 (Fail) |
| | resistance | | | |
| 3 | Adhesion | M-1.0 | M-1.0 | M-1.0 |
| 4 | Impact resistance | No film peeling | No film peeling | No film peeling |
| 5 | Moisture | M-1.0, Color | M-1.0, Color | M-1.5, Color |
| | resistance | difference (ΔE*): | difference (ΔE*): | difference (ΔE*): |
| | | 0.162 | 0.085 | 0.084 |
| | | GRAY SCALE: | GRAY SCALE: | GRAY SCALE: |
| | | grade 4 | grade 4 | grade 4 |
| 6 | Chemical | GRAY SCALE: | GRAY SCALE: | GRAY SCALE: |
| | resistance | grade 4 | grade 4 | grade 4 |
| 7 | Sunscreen | M-1.0, GRAY | M-1.0, GRAY | M-1.5, GRAY |
| | resistance | SCALE: grade 4 | SCALE: grade 4 | SCALE: grade 4 |
| 8 | Heat resistance | M-1.0, Color | M-1.0, Color | M-1.5, Color |
| | | difference (ΔE*): | difference (ΔE*): | difference (ΔE*): |
| | | 0.224 | 0.225 | 0.102 |
| | | GRAY SCALE: | GRAY SCALE: | GRAY SCALE: |
| | | grade 4 | grade 4 | grade 4 |
| 9 | Heat cycle | M-1.5, Color | M-1.5, Color | M-1.5, Color |
| | resistance | difference (ΔE*): | difference (ΔE*) | difference (ΔE*): |
| | | 0.101 | 0.093 | 0.117 |
| | | GRAY SCALE: | GRAY SCALE: | GRAY SCALE: |
| | | grade 4 | grade 4 | grade 4 |
| 10 | Light resistance | M-1.5, Color | M-1.5, Color | M-2.0, Color |
| | | difference (ΔE*): | difference (ΔE*): | difference (ΔE*): |
| | | 0.247 | 0.267 | 0.157 |
| | | GRAY SCALE: | GRAY SCALE: | GRAY SCALE: |
| | | grade 4 | grade 4 | grade 4 |
| 11 | Wear resistance | No abnormality | No abnormality | No abnormality |
| 12 | Life scratch | No abnormality | No abnormality | Wet surface |
| | resistance | | | scratches (Fail) |
| 13 | Fragrance | No abnormality | No abnormality | No abnormality |
| | resistance | | | |
| 14 | Functionality | 2:4 | 1:5 | 0:6 |
| | ratio (X:Y) | | | |
| | Judgment | Pass | Pass | Fail |

When the undercoat layer (base color layer) contained an excessive amount of curing agent, the equivalent weight of NCO relative to the hydroxyl group of the resin became excessive, so that the excess NCO functional group remaining on the surface of the painted surface reacted with water in the air, resulting in unintended side reactions and stickiness to the surface.

As shown in Tables 15 and 16, it can be seen from the results of Comparative Examples 5 and 6 that the undercoat layer (base color layer) failed to achieve the desired performance when the curing agent is included in a very small amount.

In contrast, the undercoat layer (base color layer) of the present disclosure was formed of 2-component paint in which the main portion containing some hydroxyl groups was mixed with the curing portion, but the amount of the hydroxyl group is insignificant and the main ingredient was a quick-drying acrylic resin, thus achieving fast drying during painting.

Therefore, the painting product according to various exemplary embodiments of the present disclosure is capable of realizing ‘short painting line’ and ‘exclusion of post-drying in a chamber after painting’ upon coating with the undercoat layer (base color layer), and of effectively reducing emission of organic solvents to the atmosphere without the need to use a dilution thinner unlike urethane paint upon coating with the top coat layer (clear layer).

As shown in Tables 15 and 16, the painting products according to Examples 2 to 6 of the present disclosure were capable of preventing appearance defects that may occur upon incomplete curing of the undercoat layer (base color layer), and the painted coating film can be strongly adhered to the plastic material and the top coat layer (clear layer).

The UV-photocurable top coat layer (clear layer) of various exemplary embodiments of the present disclosure was formed of urethane acrylate synthesized from non-yellowing-type isopropyl diisocyanate (IPDI) capable of increasing adhesion to the undercoat layer (base color layer), exhibiting superior heat resistance and light resistance, and increasing resistance to an external environment.

Thus, the painting products according to Examples 2 to 6 of the present disclosure satisfied physical and chemical properties required by automotive interior parts (for A-ZONE) by adjusting hardness by mixing appropriate amounts of oligomers having 2 to 6 reactive functional groups, and also were imparted with buffering properties against external instability factors.

Therefore, according to various exemplary embodiments of the present disclosure, surface hardness can be obtained while maintaining the stability of the material, the undercoat layer, and the top coat layer against thermal deformation by adjusting the reactivity and cross-linkage of the top coat layer (clear layer) and the undercoat layer (base color layer).

Therefore, the painting product according to the present disclosure can improve the customer's emotional quality by being imparted with stability and high surface hardness even under high temperature and strong UV exposure conditions.

According to various exemplary embodiments of the present disclosure, an automotive painting product according to the present disclosure is configured such that a substrate layer is coated with a base color layer and a clear layer, in which the base color layer includes a thermosetting paint composition containing a second acrylic resin having a lower glass transition temperature (Tg) than a first acrylic resin, and the clear layer includes a UV-curable paint composition containing at least two acrylate oligomers having different numbers of functional groups, thereby improving heat resistance and light resistance.

The effects of the present disclosure are not limited to the above-mentioned effects. It should be understood that the effects of the present disclosure include all effects that can be inferred from the description of the present disclosure.

Although specific embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. An automotive painting product, comprising:
a base color layer located on a substrate layer and comprising a thermosetting paint composition; and
a clear layer located on the base color layer and comprising a UV-curable paint composition,
wherein the thermosetting paint composition comprises (i) a main portion comprising a first acrylic resin, a second acrylic resin having a lower glass transition temperature (Tg) than the first acrylic resin, a first surface conditioner, a curing accelerator, and a first organic solvent, and (ii) a curing portion comprising a curing agent containing an isocyanate group and a second organic solvent, and
the UV-curable paint composition comprises at least two acrylate oligomers having different numbers of functional groups, an acrylate monomer, a photoinitiator, a second surface conditioner, a UV stabilizer, and a third organic solvent.

2. The automotive painting product of claim 1, wherein the main portion comprises, based on a total weight of the main portion, an amount of about 10 to 30 wt % of the first acrylic resin, an amount of about 10 to 30 wt % of the second acrylic resin, an amount of about 0.01 to 5 wt % of the first surface conditioner, an amount of about 0.01 to 1 wt % of the curing accelerator, and an amount of about 40 to 60 wt % of the first organic solvent, and the curing portion comprises, based on a total weight of the curing portion, an amount of about 40 to 60 wt % of the curing agent and a balance of the second organic solvent.

3. The automotive painting product of claim 1, wherein each of the first acrylic resin and the second acrylic resin comprises an amount of about 10 wt % or less of a total of hydroxyl groups, and each of the first acrylic resin and the second acrylic resin has a weight average molecular weight (Mw) of about 10,000 to 150,000 g/mol.

4. The automotive painting product of claim 1, wherein a difference in glass transition temperature (Tg) between the first acrylic resin and the second acrylic resin is about 4 to 15° C.

5. The automotive painting product of claim 1, wherein the first acrylic resin has a glass transition temperature (Tg) of about 80 to 90° C., and the second acrylic resin has a glass transition temperature (Tg) of about 70 to 80° C.

6. The automotive painting product of claim 1, wherein the curing accelerator comprises dibutyltin dilaurate.

7. The automotive painting product of claim 1, wherein the UV-curable paint composition comprises, based on a total weight of the UV-curable paint composition, an amount of about 10 to 30 wt % of the acrylate monomer, an amount of about 20 to 40 wt % of the acrylate oligomers, an amount of about 1 to 5 wt % of the photoinitiator, an amount of about 0.01 to 5 wt % of the second surface conditioner, an amount of about 0.01 to 5 wt % of the UV stabilizer, and an amount of about 30 to 70 wt % of the third organic solvent.

8. The automotive painting product of claim 1, wherein the acrylate monomer has 1 to 3 functional groups.

9. The automotive painting product of claim 1, wherein the acrylate oligomers have 2 to 6 functional groups.

10. The automotive painting product of claim 1, wherein the acrylate oligomers comprise a first acrylate oligomer having 5 to 6 functional groups and a second acrylate oligomer having 2 to 4 functional groups, and a weight ratio of the first acrylate oligomer to the second acrylate oligomer is about 5:1 to 1:5.

11. The automotive painting product of claim 1, wherein the acrylate oligomers are a urethane acrylate oligomer having at least two acryl groups.

12. The automotive painting product of claim 1, wherein the acrylate oligomers have a weight average molecular weight (Mw) of about 500 to 3,500 g/mol.

13. The automotive painting product of claim 1, wherein each of the first organic solvent, the second organic solvent, and the third organic solvent comprises one or more selected from the group consisting of an acetate-based solvent, a ketone-based solvent, and an alcohol-based solvent.

14. The automotive painting product of claim 1, wherein the substrate layer comprises a plastic injection-molded product.

15. A vehicle comprising an automotive painting product of claim 1.
